(19) United States
(12) Patent Application Publication
(10) Pub. No.: US 2026/0012588 A1
(43) Pub. Date: Jan. 8, 2026

(54) ADAPTIVE LOOP FILTER WITH ADAPTIVE FILTER STRENGTH

(71) Applicant: MEDIATEK INC., Hsinchu City (TW)

(72) Inventors: Shih-Chun CHIU, Hsinchu City (TW); Yu-Ling HSIAO, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yu-Wen HUANG, Hsinchu City (TW)

(21) Appl. No.: 18/992,788

(22) PCT Filed: Jun. 29, 2023
(86) PCT No.: PCT/CN2023/103571

§ 371 Date: Jan. 9, 2025

Related U.S. Application Data
(60) Provisional application No. 63/368,899, filed on Jul. 20, 2022.
(60) Provisional application No. 63/368,905, filed on Jul. 20, 2022.

(51) Int. Cl. H04N 19/117; H04N 19/132; H04N 19/182; H04N 19/635; H04N 19/86

(52) U.S. Cl. CPC H04N 19/117; H04N 19/132; H04N 19/182; H04N 19/635; H04N 19/86

(57) ABSTRACT

A method for performing adaptive loop filter in a video system is provided. A video coder receives data for a block of pixels to be encoded or decoded as a current block of a current picture of a video. The video coder receives a set of samples of the current block. The video coder classifies the set of samples into multiple subsets of samples. The video coder filters the received set of samples to generate a set of correction values. The video coder applies a set of filter strengths to weigh the set of generated correction values. The video coder adds the weighted set of correction values to the received set of samples as filtered samples of the current block.

### CROSS REFERENCE TO RELATED PATENT APPLICATION(S)

The present disclosure is part of a non-provisional application that claims the priority benefit of U.S. Provisional Patent Application No. 63/368,899, filed on 20 Jul. 2022, and U.S. Provisional Patent Application No. 63/368,905, filed on 20 Jul. 2022. Contents of above-listed applications are herein incorporated by reference.

### TECHNICAL FIELD

The present disclosure relates generally to video coding. In particular, the present disclosure relates to methods of coding video pictures using adaptive loop filter (ALF).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for performing adaptive loop filter in a video system. A video coder receives data for a block of pixels to be encoded or decoded as a current block of a current picture of a video. The video coder receives a set of samples of the current block. The video coder classifies the set of samples into multiple subsets of samples. The video coder filters the received set of samples to generate a set of correction values. The video coder applies a set of filter strengths to weigh the set of generated correction values. The video coder adds the weighted set of correction values to the received set of samples as filtered samples of the current block.

In some embodiments, each sample of the set of samples may be classified based on a relationship of the sample with its neighbors and based on an edge offset mode of the current block into one of the plurality of subsets of samples. In some embodiments, the set of samples are classified into the multiple subsets based on a predetermined pattern. The predetermined pattern may be selected from multiple predetermined patterns (e.g., 1 of 15 on/off 2×2 patterns.) In some embodiments, the set of samples are classified into the multiple subsets by a model that is signaled in a bitstream of coded video, or trained by online or off-line data.

In some embodiments, the filter is an adaptive loop filter (ALF) of video coding system. The filtering maybe based on a set of filter taps receiving input including (i) samples within the current block, (ii) samples neighboring the current block, or (iii) residual samples that are generated based on a prediction of the current block. The filtering may be based on a set of filter taps receiving input including (i) samples generated by a deblock filter (DBF) or a sample adaptive offset (SAO) filter or (ii) reconstructed samples of the current block without deblock filtering.

The encoder applies (at block 840) a set of filter strengths to weigh the set of generated correction values. In some embodiments, the filtering of each subset (or class) of samples can be individually turned on or off. In some embodiments, the filtering of each subset of samples can be weighed by a corresponding filter strength. In some embodiments, the encoder may turn off the filtering of a subset of samples by setting a corresponding filter strength to zero (or turn on the filtering of the subset by setting the corresponding filter strength to a non-zero value). In some embodiments, the set of filter strengths are indicated at a first, higher level of the video (e.g., slice level), and whether to apply the filter strengths is determined at a second, lower level of the video (e.g., CTB level). In some embodiments, the set of filter strengths is determined by applying a filter strength model to the set of samples, wherein the filter strength model is signaled in a bitstream of coded video. In some embodiments, the filtering is based on a set of filter taps receiving input comprising (i) samples within the current block, (ii) samples neighboring the current block, or (iii) residual samples that are generated based on a prediction of the current block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1A-B illustrate two diamond filter shapes for Adaptive Loop Filters (ALF).

FIG. 2 illustrates a system level diagram of loop filters, in which reconstructed or decoded samples are filtered or processed by deblock filter (DBF), sample adaptive offset (SAO), and adaptive filter (ALF).

FIG. 3 illustrates filtering in cross-component ALF (CC-ALF).

FIGS. 4A-B illustrate on-off selection patterns.

FIGS. 5A-B conceptually illustrate the classification of samples for ALF for applying filter strengths.

FIG. 6 illustrates an example video encoder that implement in-loop filters.

FIG. 7 illustrates portions of the video encoder that implement ALF with adaptive filter strength.

FIG. 8 conceptually illustrates a process for applying adaptive filter strengths in an adaptive loop filter (ALF).

FIG. 9 illustrates an example video decoder that may implement adaptive loop filter (ALF).

FIG. 10 illustrates portions of the video decoder that implement ALF with adaptive filter strength.

FIG. 11 conceptually illustrates a process for applying adaptive filter strengths in an adaptive loop filter (ALF).

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Adaptive Loop Filter

### A. Filter Shape

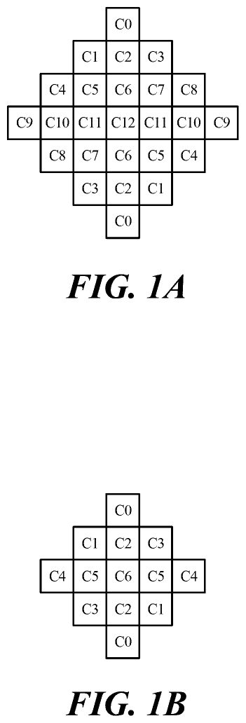

Adaptive Loop Filter (ALF) is an in-loop filtering technique used in video coding standards such as VVC. It is a block-based filter that minimizes the mean square error between original and reconstructed samples. For the luma component, one among 25 filters is selected for each 4×4 block, based on the direction and activity of local gradients. FIG. 1A-B illustrate two diamond filter shapes for Adaptive Loop Filters (ALF). FIG. 1A shows a 7×7 diamond shape that is applied for luma component. FIG. 1B shows a 5×5 diamond shape that is applied for chroma components.

### B. Block Classification

For luma component, each 4×4 block is categorized into one out of 25 classes. The classification 15 index C is derived based on its directionality D and a quantized value of activity A according to the following:

$$C = 5 D + \hat{A}$$

To calculate D and A, gradients of the horizontal, vertical and two diagonal directions are first calculated using 1-D Laplacian:

$${g}_{v} = {\sum }_{k = i - 2}^{i + 3} {\sum }_{l = j - 2}^{j + 3} {v}_{k , l} , {V}_{k , l} = \vert 2 R ( k , l ) - R ( k , l - 1 ) - R ( k , l + 1 ) \vert$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert$$

Where indices i and j refer to the coordinates of the upper left sample within the 4×4 block and R(i, j) indicates a reconstructed sample at coordinate (i, j). To reduce the complexity of block classification, the subsampled 1-D Laplacian calculation is applied. The same subsampled positions may be used for gradient calculation of all directions. (The subsampled positions may be for vertical gradient, horizontal gradient, or diagonal gradient.) The D maximum and minimum values of the gradients of horizontal and vertical directions are set as:

$${g}_{h , v}^{max} = max ( {g}_{h} , {g}_{v} ) ,$$

$${g}_{h , v}^{min} = min ( {g}_{h} , {g}_{v} )$$

The maximum and minimum values of the gradient of two diagonal directions are set as:

$${g}_{d 0 , d 1}^{max} = max ( {g}_{d 0} , {g}_{d 1} ) ,$$

$${g}_{d 0 , d 1}^{min} = min ( {g}_{d 0} , {g}_{d 1} )$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2, otherwise D is set to 1.
Step 4. If

$${g}_{d 0 , d 1}^{max} > {t}_{2} \cdot {g}_{d 0 , d 1}^{min} ,$$

D is set to 4, otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} )$$

A is further quantized to the range of 0 to 4, inclusively, and the quantized value is denoted as Â. For chroma components in a picture, no classification method is applied.

### C. Geometric Transformation of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality. There are three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 )$$

$$Rotation : {f}_{R} ( k , l ) = f ( K - l - 1 , k ) , {c}_{R} ( k , l ) = c ( K - l - 1 , k )$$

where K is the size of the filter and 0≤k, 1≤K−1 are coefficients coordinates, such that location (0,0) is at the upper left corner and location (K−1, K−1) is at the lower right corner. The transformations are applied to the filter coefficients f(k, l) and to the clipping values c(k,l) depending on gradient values calculated for that block. The relationship between the transformation and the four gradients of the four directions are summarized in Table 1 below that shows Mapping of the gradient calculated for one block and transformation.

TABLE 1

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### D. Filtering Process

At decoder side, when ALF is enabled for a CTB, each sample R′(i, j) within the CU is filtered, resulting in sample value R′(i, j) as shown below:

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 )$$

where f(k, l) denotes the decoded filter coefficients, K (x, y) is the clipping function and c(k, l) denotes the decoded clipping parameters. The variable k and/vary between −L/2 and L/2, wherein L denotes the filter length. The clipping function K (x, y)=min(y, max(−y, x)) which corresponds to the function Clip3 (−y, y, x). The clipping operation introduces non-linearity to make ALF more efficient by reducing the impact of neighbor sample values that are too different with the current sample value.

### E. Cross Component Adaptive Loop Filter (CC-ALF)

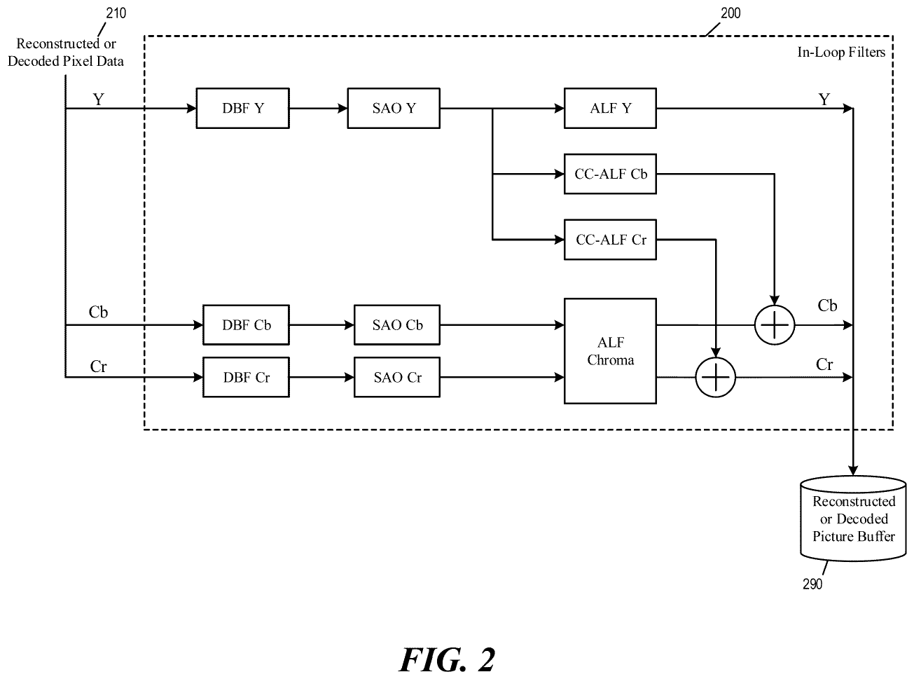

CC-ALF may use luma sample values to refine each chroma component by applying an adaptive, linear filter to the luma channel and then using the output of this filtering operation for chroma refinement. FIG. 2 illustrates a system level diagram of loop filters 200, in which reconstructed or decoded samples 210 are filtered or processed by deblock filter (DBF), sample adaptive offset (SAO), and adaptive filter (ALF). The reconstructed or decoded samples 210 may be generated from prediction signals and residual signals of the current block.

The figure shows placement of CC-ALF with respect to other loop filters. Specifically, the luma component of the SAO output is processed by a luma ALF process (ALF Y) and a pair of cross-component ALF processes (CC-ALF Cb and CC-ALF Cr). The two cross-component ALF processes generate cross-component offset for Cb and Cb components to be added to the output of a chroma ALF process (ALF chroma) to generate ALF output for the chroma components. The luma and chroma components of the ALF output are then stored in a reconstructed or decoded picture buffer 290 to be used for predictive coding of subsequent pixel blocks.

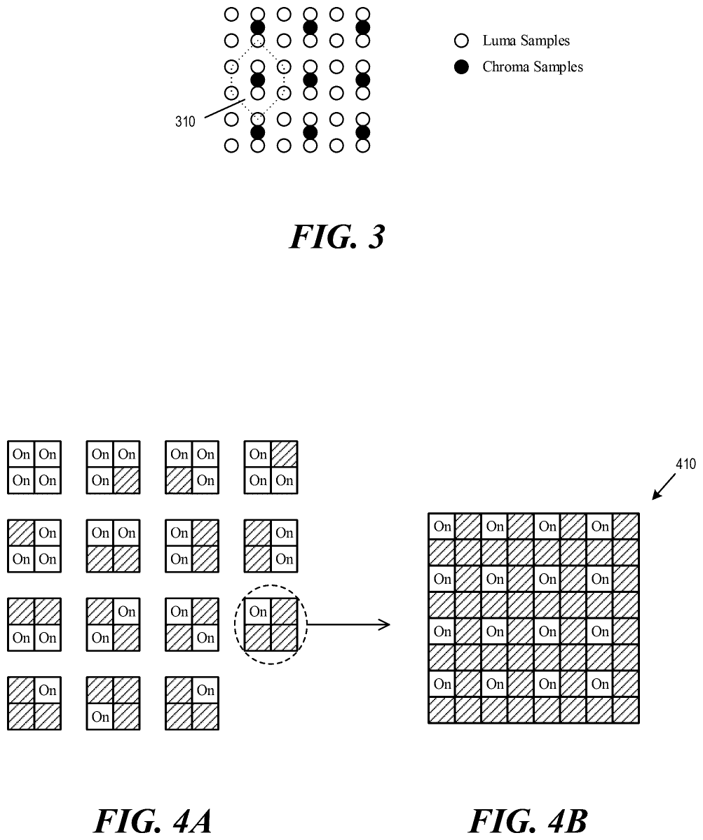

FIG. 3 illustrates filtering in cross-component ALF (CC-ALF), which is accomplished by applying a linear, diamond shaped filter 310 to the luma channel. One filter is used for each chroma channel, and the operation is expressed as

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined (x_{Y}, y_{Y}) is the luma location based on (x, y), Sᵢ is filter support area in luma component, c, (x₀,y₀) represents the filter coefficients. As shown in FIG. 3, the luma filter support is the region collocated with the current chroma sample after accounting for the spatial scaling factor between the luma and chroma planes.

CC-ALF filter coefficients may be computed by minimizing the mean square error of each chroma channels with respect to the original chroma content. To achieve this, an algorithm may use a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

CC-ALF filtering may use a 3×4 diamond shape with 8 filter taps, with 7 filter coefficients transmitted in the APS (may be referenced in the slice header). Each of the transmitted coefficients has a 6-bit dynamic range and is restricted to power-of-2 values. The 8th filter coefficient is derived at the decoder such that the sum of the filter coefficients is equal to 0. CC-ALF filter selection may be controlled at CTU-level for each chroma component. Boundary padding for the horizontal virtual boundaries may the same memory access pattern as luma ALF.

As an additional feature, the reference encoder can be configured to enable some basic subjective tuning through the configuration file. When enabled, the VTM attenuates the application of CC-ALF in regions that are coded with high quantization parameter (QP) and are either near mid-grey or contain a large amount of luma high frequencies. Algorithmically, this is accomplished by disabling the application of CC-ALF in CTUs where any of the following conditions are true:
(i) The slice QP value minus 1 is less than or equal to the base QP value
(ii) The number of chroma samples for which the local contrast is greater than (1<<(bitDepth−2))−1 exceeds the CTU height, where the local contrast is the difference between the maximum and minimum luma sample values within the filter support region
(iii) More than a quarter of chroma samples are in the range between

$$( 1 ≪ ( bitDepth - 1 ) ) - 16 and ( 1 ≪ ( bitDepth - 1 ) ) + 16$$

This is for providing some assurance that CC-ALF does not amplify artifacts introduced earlier in the decoding path.

### F. Filter Parameter Signaling

ALF filter parameters are signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signaled.

Clipping value indexes, which are decoded from the APS, allow determining clipping values using a table of clipping values for both luma and Chroma components. These clipping values are dependent of the internal bit-depth. More precisely, the clipping values are obtained by the following formula:

$$ALFClip = \{ round ( {2}^{B - α * n} ) for n ∈ [ 0 … N - 1 ] \}$$

with B equal to the internal bit-depth, a is a pre-defined constant value equal to 2.35, and N equal to 4 which is the number of allowed clipping values in VVC. The ALFClip is then rounded to the nearest value with the format of power of 2.

In slice header, up to 7 APS indices can be signaled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signaled for a luma CTB to indicate which filter set is applied. The 16 fixed filter sets are pre-defined and hard-coded in both the encoder and the decoder.

For chroma components, an APS index may be signaled in slice header to indicate the chroma filter sets being used for the current slice. At CTB level, a filter index is signaled for each chroma CTB if there is more than one chroma filter set in the APS. The filter coefficients are quantized with norm equal to 128. In order to restrict the multiplication complexity, a bitstream conformance is applied so that the coefficient value of the non-central position shall be in the range of −2⁷ to 2⁷−1, inclusive. The central position coefficient is not signalled in the bitstream and is considered as equal to 128.

G. ALF Simplification with Filtering by Fixed Filters

In some embodiments, ALF gradient subsampling and ALF virtual boundary processing are removed. Block size for classification is reduced from 4×4 to 2×2. Filter size for both luma and chroma, for which ALF coefficients are signalled, is increased to 9×9.

To filter a luma sample, three different classifiers (C₀, C₁ and C₂) and three different sets of filters (F₀, F₁ and F₂) may be used. Sets F₀ and F₁ contain fixed filters, with coefficients trained for classifiers C₀ and C₁. Coefficients of filters in F₂ are signaled. Which filter from a set Fᵢ is used for a given sample is decided by a class Cᵢ assigned to this sample using classifier Cᵢ. At first, two 13×13 diamond shape fixed filters F₀ and F₁ are applied to derive two intermediate samples R₀(x, y) and R₁(x, y). After that, F₂ is applied to R₀(x, y) and R₁(x, y) and neighboring samples to derive a filtered sample as:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ]$$

where f_{i,j} is the clipped difference between a neighboring sample and current sample R(x, y) and gᵢ is the clipped difference between Rᵢ₋₂₀(x, y) and the current sample. The filter coefficients cᵢ, i=0, . . . 21, are signaled.

Based on directionality Dᵢ and activity Âᵢ, a class Cᵢ is assigned to each 2×2 block:

$${C}_{i} = {Â}_{i} * {M}_{D , i} + {D}_{i}$$

where M_{D,i} represents the total number of directionalities Dᵢ. The values of the horizontal, vertical, and two diagonal gradients may be calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${ℊ}_{h}^{i} , {ℊ}_{v}^{i} , {ℊ}_{d 1}^{i} and {ℊ}_{d 2}^{i} .$$

The directionality Dᵢ is determined by comparing:

$${r}_{h , v}^{i} = \frac{max ( {ℊ}_{h}^{i} , {ℊ}_{v}^{i} )}{min ( {ℊ}_{h}^{i} , {ℊ}_{v}^{i} )} , {r}_{d 1 , d 2}^{i} = \frac{max ( {ℊ}_{d 1}^{i} , {ℊ}_{d 2}^{i} )}{min ( {ℊ}_{d 1}^{i} , {ℊ}_{d 2}^{i} )}$$

with a set of thresholds. The directionality D₂ is derived using thresholds 2 and 4.5. For D₀ and D₁, horizontal/vertical edge strength

$${E}_{H V}^{i}$$

and diagonal edge strength

$${E}_{D}^{i}$$

are calculated first. Thresholds Th=[1.25, 1.5, 2, 3, 4.5, 8] are used. Edge strength

$${E}_{H V}^{i}$$

is 0 if

$${r}_{h , v}^{i} \leq Th [ 0 ] ;$$

otherwise,

$${E}_{H V}^{i}$$

is the maximum integer such that

$${r}_{h , v}^{i} > Th [ {E}_{HV}^{i} - 1 ] .$$

Edge strength

$${E}_{D}^{i}$$

is 0 if

$${r}_{d 1 , d 2}^{i} \leq Th [ 0 ] ;$$

otherwise,

$${E}_{D}^{i}$$

is the maximum integer such that

$${r}_{d 1 , d 2}^{i} > Th [ {E}_{D}^{i} - 1 ] .$$

Table 2(a) and Table 2(b) below show Mapping of Eⁱ_{D} and Eⁱ_{HV} to Di. When

$${r}_{h , v}^{i} > {r}_{d 1 , d 2}^{i} ,$$

i.e. horizontal/vertical edges are dominant, Dᵢ is derived by using Table 2(a) below. Otherwise, diagonal edges are dominant, and Dᵢ is derived by using Table 2(b).

TABLE 2(a)

E_{D}ⁱ

| E_{HV}ⁱ | 0 | 1 | 2 | 3 | 4 | 5 | 6 |
|---|---|---|---|---|---|---|---|
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2(b)

E_{HV}ⁱ

| E_{D}ⁱ | 0 | 1 | 2 | 3 | 4 | 5 | 6 |
|---|---|---|---|---|---|---|---|
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain activity Âᵢ, the sum of vertical and horizontal gradients Aᵢ is mapped to the range of 0 to n, where n is equal to 4 for Â₂ and 15 for Â₀ and Â₁. In an ALF_APS, up to 4 luma filter sets are signalled, each set may have up to 25 filters.

### II. Adaptive Filter Controls

A. ALF with On/Off Control

The ALF filters are derived by optimizing the frame-level sum-of-square distortion (SSD). However, since the number of coefficients of the filters are limited, although filters are adaptively selected for each CTB, the filters may not benefit all of the samples of the CTB. Some samples are not well-suited for ALF filtering and even become worse upon ALF filtering. Some embodiments of the disclosure provide ALF on/off control mechanisms at a level lower than the CTB level.

In some embodiments, sample-level on/off control is realized by using a Sample-Adaptive-Offset-Edge-Offset-like (SAO-EO-like) classifier. In some embodiments, for each CTB, given an edge offset (EO) mode (direction of an edge), samples are classified into more than one classes, and each class may have its own on/off selection. (Each sample is classified based on a direction that is determined from the sample's relationship or difference with its neighbors.)

In some embodiments, the EO mode and the on/off selection of each class are signaled at CTB level. In another embodiment, the EO mode is signaled at CTB level while the on/off selection of each class is signaled at a higher level. In another embodiment, both EO mode and on/off selection of each class are signaled at a higher level.

In some embodiments, sample-level on/off control follows a specific pattern selected by CTB. In some embodiments, each CTB selects one of several 2×2 on/off patterns, and the on/off selection of each 2×2 block is determined accordingly. FIGS. 4A-B illustrate on-off selection patterns. FIG. 4A shows 15 possible on-off patterns for 2×2 blocks. FIG. 4B shows on-off selection in one CTB 410, in which one of the 15 2×2 patterns is selected and applied throughout the CTB.

In some embodiments, lower-level on/off control is achieved by considering the ALF block classes. Specifically, each block class derived by an ALF classifier may have its own ALF on/off selection. In some embodiments, each class on/off selection is signaled at a filter set level. In some embodiments, each class on/off selection is signaled at slice level.

In some embodiments, a model is used to determine whether to apply ALF or not for each sample or each block. In some embodiments, the model is an offline-trained classifier. In some embodiments, the model is an online-trained classifier. The classifier can be a probability-based model, a decision-tree-based model, a support vector machine (SVM), or a neural-network-based model.

B. ALF with Adaptive Filter Strength

Some embodiments of the disclosure provide an ALF based on adaptive filter strength. In general, ALF reconstruction process can be represented by:

$$\tilde{R} ( x , y ) = R ( x , y ) + [ {\sum }_{i = 0}^{K - 1} {c}_{i} {n}_{i} ] = R ( x , y ) + {R}_{ALF} ,$$

where R(x, y) is the sample value before ALF filtering, \tilde{R}(x, y) is the sample value after ALF filtering, cᵢ is the i-th filter coefficient, nᵢ is the i-th filter tap input, and R_{ALF} is the correction value or offset from ALF. The filter tap input nᵢ may be a clipped neighboring difference value, a correction value from another filter (e.g., deblock filter or ALF fixed filter), a correction value from another in-loop filtering stage. The filter tap input mi may also be generated based on pre-ALF current and neighboring samples, fixed filtered current and neighboring samples, pre-deblocking filter current and neighboring samples, residual current sample and fixed-filtered residual sample, etc.

When a filter strength s is applied, the reconstruction process is modified as:

$$\tilde{R} ( x , y ) = R ( x , y ) + s \times {R}_{ALF}$$

In some embodiments, the ALF on/off control described above can be implemented as the filter strength s, namely, filter strength s=0 indicates ALF is off and filter strength s=1 or s>0 indicates ALF is on.

In some embodiments, one or more filter strength values are indicated at a higher level, and whether to apply the filter strength is determined at a lower level. In some embodiments, one filter strength value is indicated at slice level. For each CTB for which ALF is turned on (ALF-on CTB), one additional flag may be signaled to indicate whether to apply the filter strength. In some embodiments, one filter strength value is signaled for each APS or filter set at the slice level. For each ALF-on CTB, the applied filter strength is determined according to the APS or filter set selection.

In some embodiments, one or more filter strength models are signaled at a higher level, and whether to apply the filter strength and which filter strength model to use can be adaptively determined at a lower level. In one embodiment, one filter strength model is signaled at slice level. For each ALF-on CTB, always apply the filter strength using the signaled model. In some embodiments, one filter strength model is signaled at slice level. For each ALF-on CTB, one additional flag is signaled to indicate whether to apply the filter strength derived by the signaled model. In another embodiment, several filter strength models are signaled at slice level. For each ALF-on CTB, additional flags are signaled for filter strength model selection.

In some embodiments, for one ALF-on CTB, the video coder may apply different filter strengths to different subsets of samples in the CTB. In some embodiments, samples are split into subsets based on predetermined patterns. In another embodiment, samples are split into subsets based on one or more Sample-Adaptive-Offset-Edge-Offset-like (SAO-EO-like) classifiers. In some embodiments, samples are split into subsets or classes based on neural-network-based models.

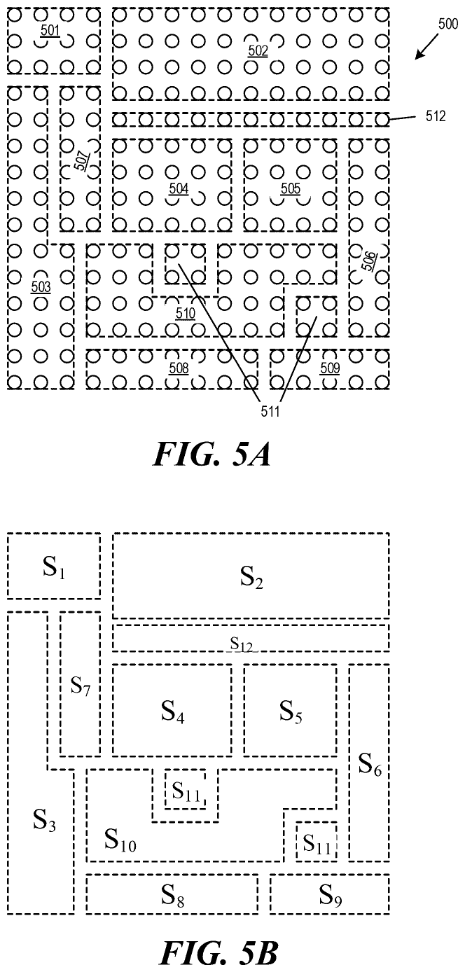

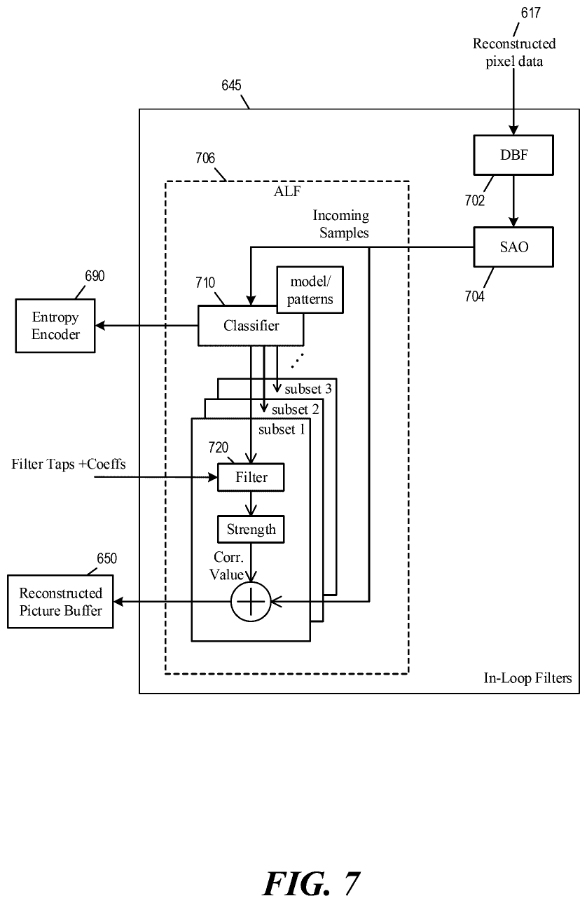

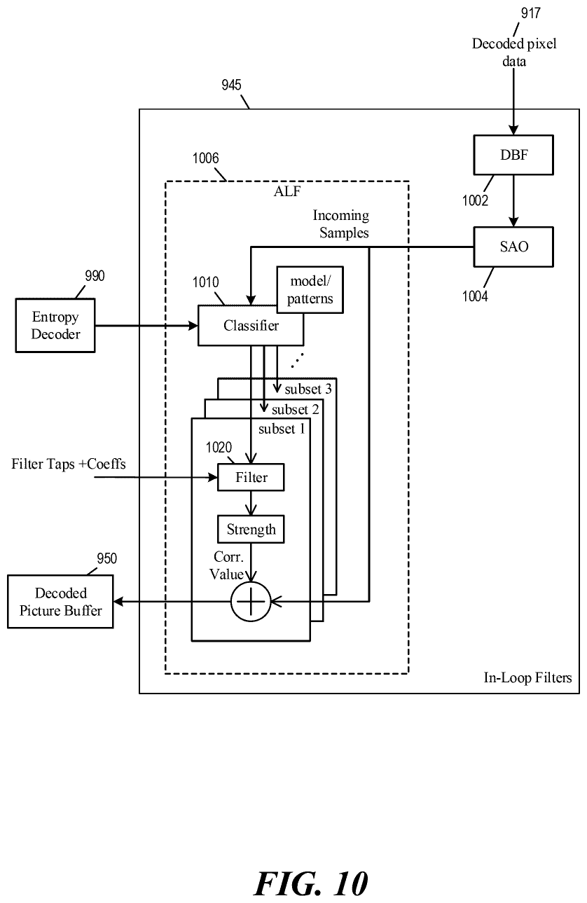

FIGS. 5A-B conceptually illustrate the classification of samples for ALF for applying filter strengths. FIG. 5A illustrates a set of samples 500 for ALF operation for a particular CTB. The set of samples 500 are classified into 12 different subsets (or classes) of samples 501-512. The classification may be based on any of the classification described above in Sections II-A and II-B, such as classifying each sample based on its relationships with its neighbors according to an edge offset mode of the CTB, or partitioning the samples of the CTB based on a predetermined pattern that is selected from multiple different predetermined patterns, or classifying each sample by a model that is specified in a bitstream of coded video. In some embodiments, ALF filtering may be individually turned on or off for each of the subsets. In some embodiments, ALF filtering strength may be individually determined for each of the subsets. FIG. 5B shows filtering strengths S₁-S₁₂ may be applied to sample subsets 501-512 respectively. Further examples of ALF with adaptive filter strengths will be described by reference to FIG. 7 and FIG. 10.

The foregoing proposed methods can be implemented in video encoders and/or decoders. For example, the proposed method can be implemented in an in-loop filtering module of an encoder, and/or an in-loop filtering module of a decoder.

### III. Example Video Encoder

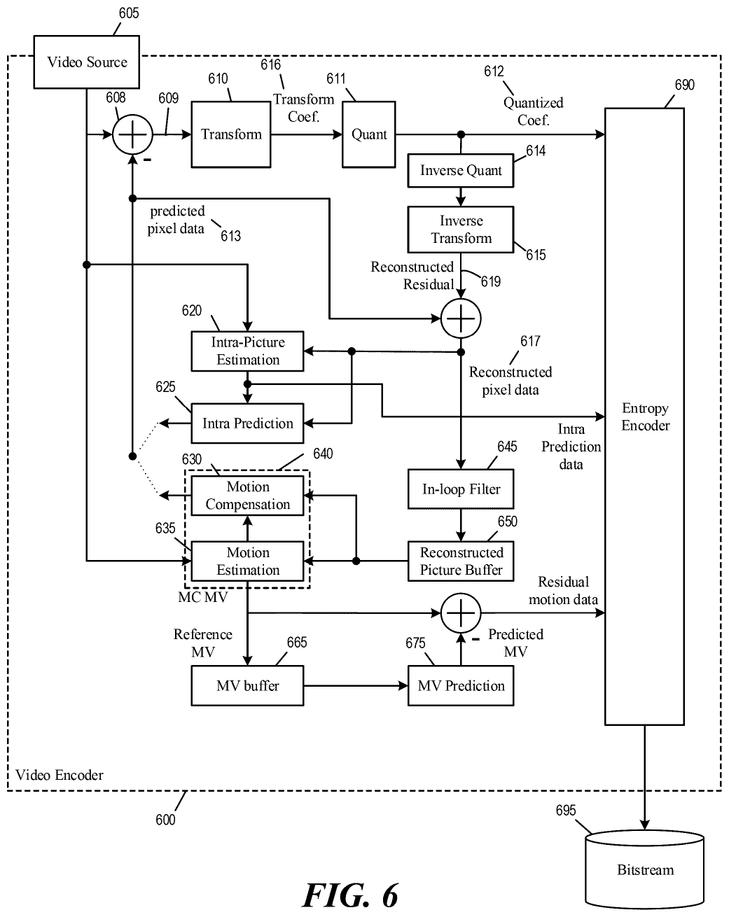

FIG. 6 illustrates an example video encoder 600 that implement in-loop filters. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

FIG. 7 illustrates portions of the video encoder 600 that implement ALF with adaptive filter strength. Specifically, the figure illustrates the components of the in-loop filters 645 of the video encoder 600. As illustrated, the in-loop filter 645 receives the reconstructed pixel data 617 of a current block (e.g., current CTB) and produces filtered output to be stored in the reconstructed picture buffer 650. The incoming pixel data are processed in the in-loop filter 645 by a deblock filtering module (DBF) 702 and a sample adaptive offset (SAO) module 704. The processed samples produced by the DBF and the SAO are provided to an adaptive loop filter (ALF) module 706. An example in-loop filter 200 with DBF, SAO, and ALF is described by reference to FIG. 2 above.

The ALF module 706 includes a classifier 710. The classifier 710 classifies each incoming sample (from SAO and DBF) into one of several different subsets (or classes). The classifier 610 may perform the classification of the samples according to a predefined pattern. The selection of the predefined pattern may be signaled by the entropy encoder 690 into the bitstream. The classification may also be performed according to a model. Classification by model and/or patterns are described in Section II-A and Section II-B above.

Each sample classified into a particular subset of samples is used to generate a correction value to be added to the sample. The correction value is generated by applying a filter 720 to the sample. The filter coefficients of the filter 720 may be signaled in the bitstream by the entropy encoder 690. The filter taps of the filter 720 may include samples of the current block (e.g., current CTB), neighboring blocks of the current block (provided by the reconstructed picture buffer 650), or the reconstructed residuals 619 of the current block. The generated correction value is weighted by a filter strength that is specific to the particular subset to which the sample belongs. In some embodiments, filtering for the particular subset of samples can be turned off or on by e.g., setting the subset's filter strength to zero or to a non-zero value. The filter strengths of the different subsets may be signaled by the entropy encoder 690 in the bitstream.

Incoming samples to the ALF module 706 are thereby combined with their corresponding correction values to generate the outputs of ALF module 706, which is also the output of the in-loop filters 645. The output of the in-loop filter 645 is stored in the reconstructed picture buffer 650 for encoding of subsequent blocks.

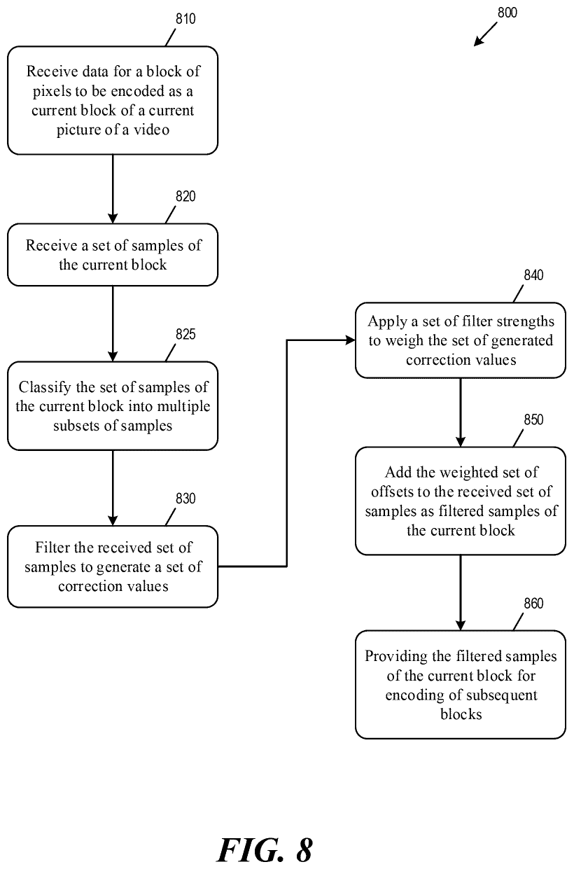

FIG. 8 conceptually illustrates a process 800 for applying adaptive filter strengths in an adaptive loop filter (ALF). In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder receives (at block 810) data to be encoded as a current block of a current picture of a video. The current block may be a coding tree block (CTB). The encoder receives (at block 820) a set of samples of the current block.

The encoder classifies (at block 825) the set of samples into multiple subsets (or classes) of samples. In some embodiments, each sample of the set of samples may be classified based on a relationship of the sample with its neighbors and based on an edge offset mode of the current block into one of the plurality of subsets of samples. In some embodiments, the set of samples are classified into the multiple subsets based on a predetermined pattern. The predetermined pattern may be selected from multiple predetermined patterns (e.g., 1 of 15 on/off 2×2 patterns.) In some embodiments, the set of samples are classified into the multiple subsets by a model that is signaled in a bitstream of coded video, or trained by online or off-line data.

The encoder filters (at block 830) the received set of samples to generate a set of correction values. In some embodiments, the filter is an adaptive loop filter (ALF) of video coding system. The filtering maybe based on a set of filter taps receiving input including (i) samples within the current block, (ii) samples neighboring the current block, or (iii) residual samples that are generated based on a prediction of the current block. The filtering may be based on a set of filter taps receiving input including (i) samples generated by a deblock filter (DBF) or a sample adaptive offset (SAO) filter or (ii) reconstructed samples of the current block without deblock filtering.

The encoder applies (at block 840) a set of filter strengths to weigh the set of generated correction values. In some embodiments, the filtering of each subset (or class) of samples can be individually turned on or off. In some embodiments, the filtering of each subset of samples can be weighed by a corresponding filter strength. In some embodiments, the encoder may turn off the filtering of a subset of samples by setting a corresponding filter strength to zero (or turn on the filtering of the subset by setting the corresponding filter strength to a non-zero value). In some embodiments, the set of filter strengths are indicated at a first, higher level of the video (e.g., slice level), and whether to apply the filter strengths is determined at a second, lower level of the video (e.g., CTB level). In some embodiments, the set of filter strengths is determined by applying a filter strength model to the set of samples, wherein the filter strength model is signaled in a bitstream of coded video. In some embodiments, the filtering is based on a set of filter taps receiving input comprising (i) samples within the current block, (ii) samples neighboring the current block, or (iii) residual samples that are generated based on a prediction of the current block.

The encoder adds (at block 850) the weighted set of correction values to the received set of samples as filtered samples of the current block. The encoder provides (at block 860) the filtered samples of the current block for encoding subsequent blocks of the video (e.g., stored in the reconstructed picture buffer 650.)

### IV. Example Video Decoder

In some embodiments, an encoder may signal (or generate) one or more syntax element in a bitstream, such that a decoder may parse said one or more syntax element from the bitstream.

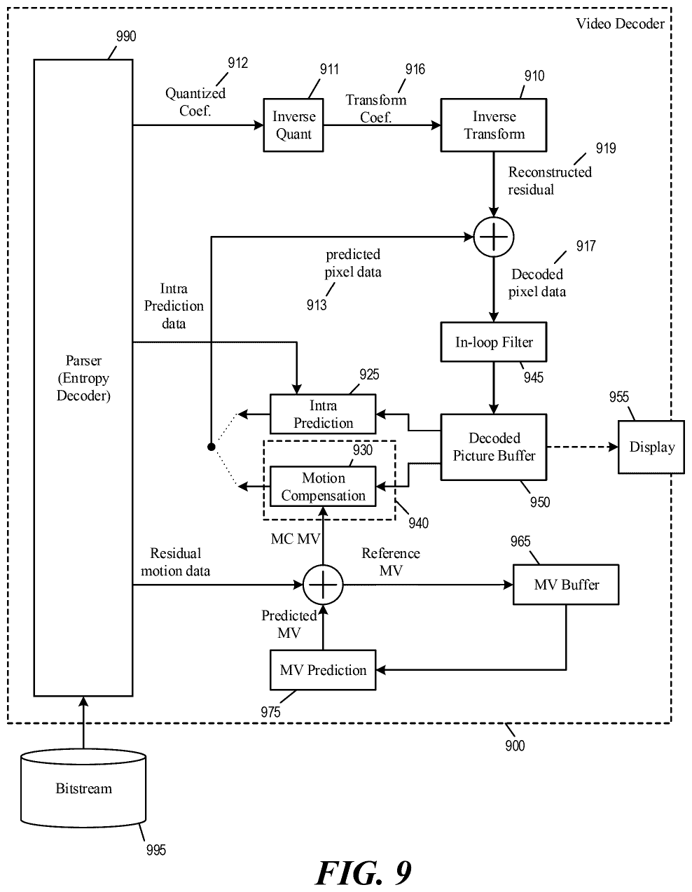

FIG. 9 illustrates an example video decoder 900 that may implement adaptive loop filter (ALF). As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

FIG. 10 illustrates portions of the video decoder 900 that implement ALF with adaptive filter strength. Specifically, the figure illustrates the components of the in-loop filters 945 of the video decoder 900. As illustrated, the in-loop filter 945 receives the decoded pixel data 917 of a current block (e.g., current CTB) and produces filtered output to be stored in the decoded picture buffer 950. The incoming pixel data are processed in the in-loop filter 945 by a deblock filtering module (DBF) 1002 and a sample adaptive offset (SAO) module 1004. The processed samples produced by the DBF and the SAO are provided to an adaptive loop filter (ALF) module 1006. An example in-loop filter 200 with DBF, SAO, and ALF is described by reference to FIG. 2 above.

The ALF module 1006 includes a classifier 1010. The classifier 1010 classifies each incoming sample (from SAO and DBF) into one of several different subsets (or classes). The classifier 910 may perform the classification of the samples according to a predefined pattern. The selection of the predefined pattern may be parsed by the entropy decoder 990 from the bitstream. The classification may also be performed according to a model. Classification by model and/or patterns are described in Section II-A and Section II-B above.

Each sample classified into a particular subset of samples is used to generate a correction value to be added to the sample. The correction value is generated by applying a filter 1020 to the sample. The filter coefficients of the filter 1020 may be received from the bitstream by the entropy decoder 990. The filter taps of the filter 1020 may include samples of the current block (e.g., current CTB), neighboring blocks of the current block (provided by the decoded picture buffer 950), or the reconstructed residuals 919 of the current block. The generated correction value is weighted by a filter strength that is specific to the particular subset to which the sample belongs. In some embodiments, filtering for the particular subset of samples can be turned off or on by e.g., setting the subset's filter strength to zero or to a non-zero value. The filter strengths of the different subsets may be received by the entropy decoder 990 from the bitstream.

Incoming samples to the ALF module 1006 are thereby combined with their corresponding correction values to generate the outputs of ALF module 1006, which is also the output of the in-loop filters 945. The output of the in-loop filter 945 is stored in the decoded picture buffer 950 for decoding and reconstructing subsequent blocks.

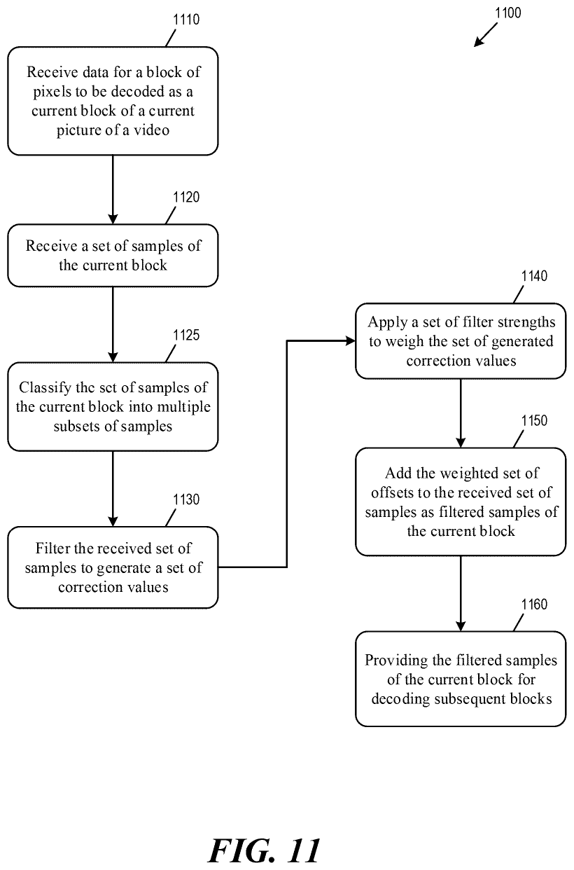

FIG. 11 conceptually illustrates a process 1100 for applying adaptive filter strengths in an adaptive loop filter (ALF). In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder receives (at block 1110) data to be decoded as a current block of a current picture of a video. The current block may be a coding tree block (CTB). The decoder receives (at block 1120) a set of samples of the current block.

The decoder classifies (at block 1125) the set of samples into multiple subsets (or classes) of samples. In some embodiments, each sample of the set of samples may be classified based on a relationship of the sample with its neighbors and based on an edge offset mode of the current block into one of the plurality of subsets of samples. In some embodiments, the set of samples are classified into the multiple subsets based on a predetermined pattern. The predetermined pattern may be selected from multiple predetermined patterns (e.g., 1 of 15 on/off 2×2 patterns.) In some embodiments, the set of samples are classified into the multiple subsets by a model that is signaled in a bitstream of coded video, or trained by online or off-line data.

The decoder filters (at block 1130) the received set of samples to generate a set of correction values. In some embodiments, the filter is an adaptive loop filter (ALF) of video coding system. The filtering maybe based on a set of filter taps receiving input including (i) samples within the current block, (ii) samples neighboring the current block, or (iii) residual samples that are generated based on a prediction of the current block. The filtering may be based on a set of filter taps receiving input including (i) samples generated by a deblock filter (DBF) or a sample adaptive offset (SAO) filter or (ii) reconstructed samples of the current block without deblock filtering.

The decoder applies (at block 1140) a set of filter strengths to weigh the set of generated correction values. In some embodiments, the filtering of each subset (or class) of samples can be individually turned on or off. In some embodiments, the filtering of each subset of samples can be weighed by a corresponding filter strength. In some embodiments, the decoder may turn off the filtering of a subset of samples by setting a corresponding filter strength to zero (or turn on the filtering of the subset by setting the corresponding filter strength to a non-zero value). In some embodiments, the set of filter strengths are indicated at a first, higher level of the video (e.g., slice level), and whether to apply the filter strengths is determined at a second, lower level of the video (e.g., CTB level). In some embodiments, the set of filter strengths is determined by applying a filter strength model to the set of samples, wherein the filter strength model is signaled in a bitstream of coded video. In some embodiments, the filtering is based on a set of filter taps receiving input comprising (i) samples within the current block, (ii) samples neighboring the current block, or (iii) residual samples that are generated based on a prediction of the current block.

The decoder adds (at block 1150) the weighted set of correction values to the received set of samples as filtered samples of the current block. The decoder provides (at block 1160) the filtered samples of the current block for decoding subsequent blocks of the video (e.g., stored in the reconstructed picture buffer 950) or for display as part of the reconstructed current picture.

### V. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

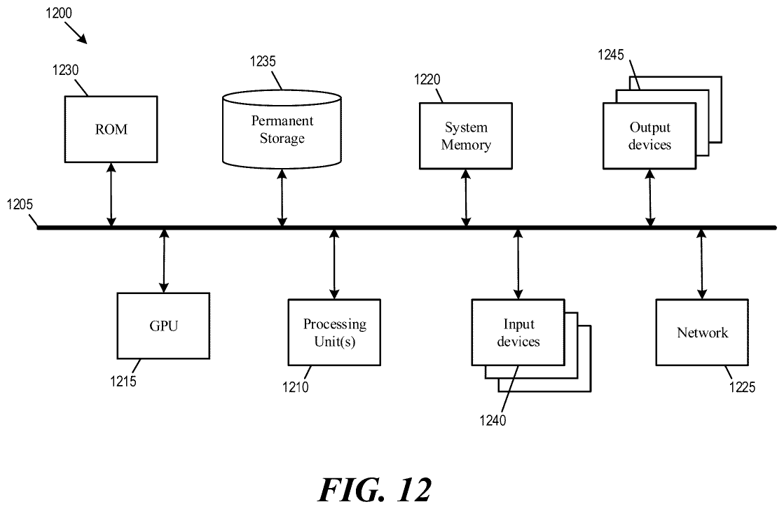

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
receiving a set of samples of the current block;
filtering the received set of samples to generate a set of correction values;
applying a set of filter strengths to weigh the set of generated correction values; and
adding the weighted set of correction values to the received set of samples as filtered samples of the current block.

2. The video coding method of claim 1, wherein the filter is an adaptive loop filter (ALF) of a video coding system in which the filtered samples of the current block are provided for encoding or decoding subsequent blocks of the current picture.

3. The video coding method of claim 1, wherein the set of samples is classified into a plurality of subsets of samples.

4. The video coding method of claim 3, wherein the filtering of each subset of samples is individually turned on or off.

5. The video coding method of claim 3, wherein the filtering of each subset of samples is weighed by a corresponding filter strength.

6. The video coding method of claim 3, wherein the filtering of a subset of samples is turned off by setting a corresponding filter strength to zero.

7. The video coding method of claim 3, wherein each sample of the set of samples is classified based on a relationship of the sample with its neighbors into one of the plurality of subsets of samples.

8. The video coding method of claim 3, wherein the set of samples are classified into the plurality of subsets based on a predetermined pattern.

9. The video coding method of claim 3, wherein the set of samples are classified into the plurality of subsets by a model.

10. The video coding method of claim 1, wherein the set of filter strengths are indicated at a first level of the video, wherein whether to apply the filter strengths is determined at a second level of the video, wherein the first level is a higher level of the video than the second level.

11. The video coding method of claim 10, wherein the first level is a slice level, and second level is a coding tree block (CTB).

12. The video coding method of claim 1, wherein the set of filter strengths is determined by applying a filter strength model to the set of samples, wherein the filter strength model is signaled in a bitstream of coded video.

13. The video coding method of claim 1, wherein the filtering is based on a set of filter taps receiving input comprising (i) samples within the current block, (ii) samples neighboring the current block, or (iii) residual samples that are generated based on a prediction of the current block.

14. The video coding method of claim 1, wherein the filtering is based on a set of filter taps having input comprising (i) samples generated by a deblock filter (DBF) or a sample adaptive offset (SAO) filter or (ii) reconstructed samples of the current block without deblock filtering.

15. An electronic apparatus comprising:
a video coder circuit configured to perform operations comprising:
receiving data for a block of pixels to be encoded or decoded as a current block of a current picture of a video;
receiving a set of samples of the current block;
filtering the received set of samples to generate a set of correction values;
applying a set of filter strengths to weigh the set of generated correction values; and
adding the weighted set of correction values to the received set of samples as filtered samples of the current block.
